(19) United States
(12) Patent Application Publication
(10) Pub. No.: US 2012/0018311 A1
(43) Pub. Date: Jan. 26, 2012

(54) CARBON DIOXIDE REDUCTION METHOD, AND CARBON DIOXIDE REDUCTION CATALYST AND CARBON DIOXIDE REDUCTION DEVICE USED FOR THE METHOD

(75) Inventors: Satoshi YOTSUHASHI, Osaka (JP); Reiko Taniguchi, Osaka (JP); Yuji Zenitani, Nara (JP)

(73) Assignee: PANASONIC CORPORATION, Osaka (JP)

(21) Appl. No.: 13/190,975

(22) Filed: Jul. 26, 2011

Related U.S. Application Data
(63) Continuation of application No. PCT/JP2010/003975, filed on Jun. 15, 2010.

(30) Foreign Application Priority Data
Dec. 4, 2009 (JP) 2009-276280

(51) Int. Cl. C25B 1/00; C01B 31/30; C25B 9/00

(52) U.S. Cl. 205/555; 204/277; 423/440

(57) ABSTRACT

The carbon dioxide reduction method of the present invention is a method including steps of: bringing an electrode (working electrode) containing a carbide of at least one element selected from Group V elements (vanadium, niobium, and tantalum) into contact with an electrolytic solution; and introducing carbon dioxide into the electrolytic solution to reduce the introduced carbon dioxide by the electrode. The material contained in the electrode, that is, the material containing a carbide of at least one element selected from Group V elements (vanadium, niobium, and tantalum) is the carbon dioxide reduction catalyst of the present invention.

### BACKGROUND OF THE INVENTION

1. Field of the Invention

The present invention relates to a carbon dioxide reduction method, and a carbon dioxide reduction catalyst and a carbon dioxide reduction device used for the method.

2. Description of Related Art

Conventionally, the development of electrode catalysts capable of electrolytically reducing carbon dioxide in a solution has focused on solid metals such as copper and silver and metal complexes such as cobalt complexes and iron complexes.

Carbon dioxide is generally a very stable molecule. Conventionally, electrical reduction of carbon dioxide requires a very high overvoltage. There are not many catalysts capable of reducing the overvoltage. Various materials have been studied as catalysts, but significant results have not been obtained. Furthermore, metals (including alloys) and molecular materials have a durability problem in that they deteriorate with time when they are used as catalysts for a long time. Therefore, catalytic materials with practical potential have not yet been found.

Some of the studies have reported catalysts for reducing carbon dioxide, which include copper, cobalt porphyrins (see D. Behar et al., “Cobalt Porphyrin Catalyzed Reduction of CO₂. Radiation Chemical, Photochemical, and Electrochemical Studies”, J. Phys. Chem. A, Vol. 102, 2870 (1998)), and nickel cyclam complexes (see M. Rudolph et al., “Macrocyclic [N₄²] Coordinated Nickel Complexes as Catalysts for the Formation of Oxalate by Electrochemical Reduction of Carbon Dioxide”, J. Am. Chem. Soc., Vol. 122, 10821 (2000)).

Meanwhile, another method has been tried to reduce carbon dioxide by reacting carbon dioxide not in a solution but with hydrogen, etc. under high temperature and high pressure conditions (see JP 2000-254508 A). A still another method has been proposed to reduce carbon dioxide by reacting carbon dioxide with alkylbenzene instead of hydrogen (see JP 01 (1989)-313313 A).

### SUMMARY OF THE INVENTION

However, the above-mentioned conventional materials for electrode catalysts capable of reducing carbon dioxide in a solution have a problem in that they still require a high overvoltage, and that the reaction does not proceed smoothly. Such conventional materials also have a durability problem in that they deteriorate with time during the long-time catalytic reaction.

Meanwhile, the above-mentioned method for reducing carbon dioxide by reacting carbon dioxide not in a solution but with hydrogen, etc. under high temperature and high pressure conditions requires high temperature and high pressure conditions for the reaction, which requires large-scale equipment. Furthermore, in this carbon dioxide reduction method, not only a reducing gas such as hydrogen must be prepared additionally but also a great deal of energy must be input.

Therefore, if a carbon dioxide reduction catalyst that is durable enough for practical use at a low overvoltage is achieved, carbon dioxide is allowed to be reduced to carbon monoxide, formic acid, methane, etc. and these substances are allowed to be provided at low cost and in an energy-saving manner. Such a carbon dioxide reduction technique is also very useful as a technique for reducing the amount of carbon dioxide. Furthermore, carbon dioxide reduction techniques are expected to be very useful as more environmentally-friendly resource recycling methods for the future if they are combined with photocatalytic technology and solar power generation.

Accordingly, it is an object of the present invention to provide a carbon dioxide reduction method and a carbon dioxide reduction device, in which carbon dioxide is reduced in a solution, and a catalytic material having high durability and capable of reducing carbon dioxide at an overvoltage equal to or lower than the overvoltages for the reduction in conventional methods and devices is used. It is a further object of the present invention to provide a carbon dioxide reduction catalyst capable of reducing carbon dioxide in a solution, having high durability, and capable of reducing carbon dioxide at an overvoltage equal to or lower than the overvoltages for the reduction by conventional carbon dioxide reduction catalysts.

The carbon dioxide reduction method of the present invention is a method including steps of: bringing an electrode containing a carbide of at least one element selected from Group V elements (vanadium, niobium, and tantalum) into contact with an electrolytic solution; and introducing carbon dioxide into the electrolytic solution to reduce the introduced carbon dioxide by the electrode.

The carbon dioxide reduction catalyst of the present invention contains a carbide of at least one element selected from Group V elements (vanadium, niobium, and tantalum).

The carbon dioxide reduction device of the present invention includes: an electrolytic solution; a vessel containing the electrolytic solution; a first electrode placed in contact with the electrolytic solution and containing a carbide of at least one element selected from Group V elements (vanadium, niobium, and tantalum); a second electrode placed in contact with the electrolytic solution and electrically connected to the first electrode; a solid electrolyte placed between the first electrode and the second electrode to separate the vessel into a region of the first electrode and a region of the second electrode; and a gas inlet for introducing carbon dioxide into the electrolytic solution.

The carbon dioxide reduction method and the carbon dioxide reduction device of the present invention are a method and a device for reducing carbon dioxide in a solution, and further use, for an electrode (first electrode) for reducing carbon dioxide, a catalytic material having high durability and capable of reducing carbon dioxide at an overvoltage equal to or lower than the overvoltages for the reduction in conventional methods and devices. Therefore, the method and the device of the present invention achieve reduction of carbon dioxide to carbon monoxide, formic acid, methane, etc. and provide these substances with less energy and at lower cost. Furthermore, the catalyst of the present invention achieves reduction of carbon dioxide in a solution, has high durability, and achieves reduction of carbon dioxide at an overvoltage equal to or lower than the overvoltages for the reduction by conventional carbon dioxide reduction catalysts.

### BRIEF DESCRIPTION OF THE DRAWINGS

FIG. 1 is a graph showing the adsorption energies of carbon dioxide and carbon monoxide on tantalum, niobium, tantalum carbide, and niobium carbide derived from electronic structure calculations.

FIG. 2A is a diagram showing the adsorption state of carbon dioxide on tantalum carbide derived from an electronic structure calculation, and FIG. 2B is a diagram showing the adsorption state of carbon monoxide on tantalum carbide derived from an electronic structure calculation.

FIG. 3 is an X-ray diffraction pattern showing the crystalline structure of a tantalum carbide deposited on a silicon substrate by sputtering.

FIG. 4 is a schematic view of an electrochemical cell used for measurements in Examples.

FIG. 5 is a graph showing the result of a C-V measurement on a tantalum carbide electrode.

FIG. 6 is a graph showing the results of C-V measurements on a niobium carbide electrode and a vanadium carbide electrode.

FIG. 7 is a graph obtained by a gas chromatographic analysis showing the production of methane, ethylene, and ethane.

FIG. 8 is a graph obtained by a gas chromatographic analysis showing the production of carbon monoxide and methane.

FIG. 9 is a graph obtained by a liquid chromatographic analysis.

### DETAILED DESCRIPTION OF THE INVENTION

The embodiment of the present invention is described below with reference to the drawings.

A carbon dioxide reduction method and a carbon dioxide reduction device in the present embodiment is a method and a device for reducing carbon dioxide in a solution by using the carbon dioxide reduction catalyst of the present invention containing a carbide of at least one element selected from Group V elements (vanadium, niobium, and tantalum).

The carbon dioxide reduction method of the present embodiment includes steps of: bringing an electrode containing a carbide of at least one element selected from vanadium, niobium, and tantalum into contact with an electrolytic solution; and introducing carbon dioxide into the electrolytic solution to reduce the introduced carbon dioxide by the electrode.

The electrode containing a carbide of at least one element selected from vanadium, niobium, and tantalum serves as a working electrode for reducing carbon dioxide. An electrode that can be used as the working electrode in the present embodiment is obtained, for example, by depositing a thin film of tantalum carbide by radio frequency (RF) sputtering on a conductive silicon substrate as an electrode substrate. In this case, the electrode substrate is not particularly limited to a conductive silicon substrate as long as it has electrical conductivity. Examples of commonly used electrode substrates include a substrate made of inert metal such as gold, and a glassy carbon substrate. The technique for forming the thin film of tantalum carbide is not particularly limited. The working electrode in which the tantalum carbide thin film as a carbon dioxide reduction catalyst is formed on the electrode substrate and the counter electrode electrically connected to the working electrode are immersed in an electrolytic solution, and carbon dioxide is introduced into the electrolytic solution. As a result, the carbon dioxide in the electrolytic solution is allowed to be reduced by the catalytic activity of tantalum carbide.

In the present embodiment, the electrode including a thin film of tantalum carbide is used, but tantalum carbide need not necessarily be such a thin film. Even with the use of an electrode in which a tantalum carbide powder is supported on an electrode substrate, the same activity can be obtained as with the use of the thin film. As described later in Examples, it was confirmed that with the use of an electrode obtained by sputtering niobium carbide or vanadium carbide, carbon dioxide was reduced in the same manner as with the use of tantalum carbide. In this method, the reaction is carried out in the solution (electrolytic solution). Therefore, it is desirable to adjust the supporting or deposition conditions for each of these catalytic substances so that it can be stably supported or deposited on the electrode substrate in the solution.

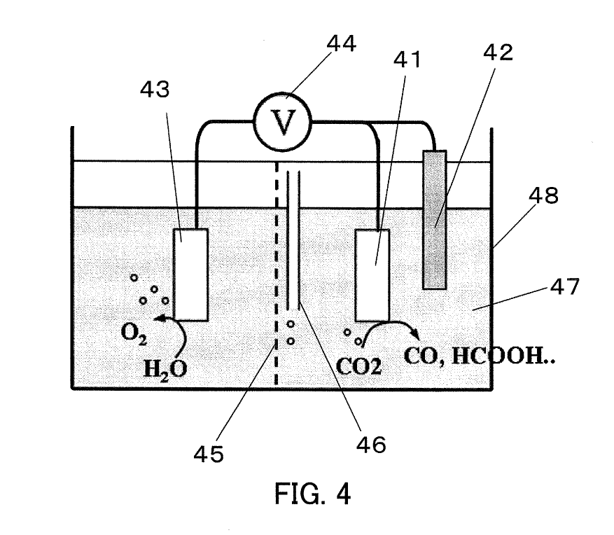

As an embodiment of the carbon dioxide reduction device of the present invention, a device having the same configuration as that of an electrochemical cell (see FIG. 4) used in Examples below can be used. Specifically, the carbon dioxide reduction device of the present embodiment can be configured as a device including: an electrolytic solution 47; a vessel 48 containing the electrolytic solution 47; a working electrode (first electrode) 41 placed in the electrolytic solution 47 and containing a carbide of at least one element selected from Group V elements (vanadium, niobium, and tantalum); a counter electrode (second electrode) 43 placed in the electrolytic solution 47 and electrically connected to the working electrode 41; a solid electrolyte membrane 45 placed between the working electrode 41 and the counter electrode 43 to separate the vessel 48 into a region of the working electrode 41 and a region of the counter electrode 43; and a gas inlet 46 for introducing carbon dioxide into the electrolytic solution 47. In FIG. 4, the working electrode 41 and the counter electrode 43 are completely immersed in the electrolytic solution 47, but their placement is not limited to this as long as the working electrode 41 and the counter electrode 43 are placed in contact with the electrolytic solution 47. The electrochemical cell shown in FIG. 4 is a three-electrode cell provided further with a reference electrode 42 for the measurements in Examples. The reference electrode 42 need not necessarily be provided because it is not necessary to measure the potential when the electrochemical cell is used as a carbon dioxide reduction device.

Although the details are described later in Examples, when an electrode in which a tantalum carbide thin film was formed on a conductive silicon substrate was prepared, carbon dioxide was reduced by the electrode, and substances produced by the reduction were analyzed, it was confirmed that carbon monoxide, formic acid, methane, and ethanol were produced. In this analysis, a gas chromatograph was used to analyze gas components, and a liquid chromatograph was used to analyze liquid components.

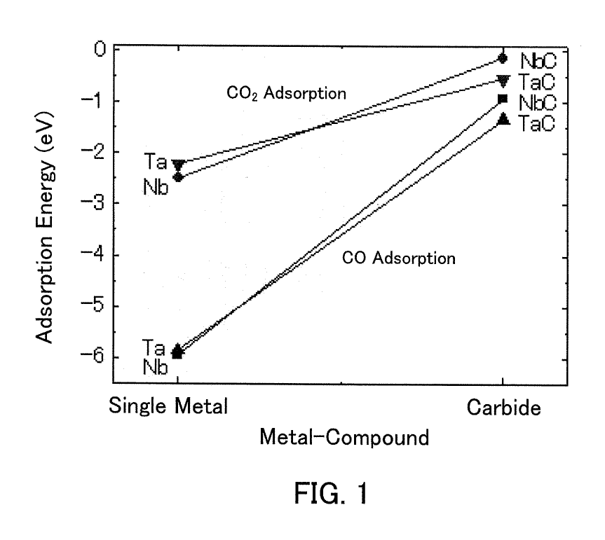

The rationale for the finding that the material containing a carbide of at least one element selected from vanadium, niobium, and tantalum is used as a carbon dioxide reduction catalyst is described in detail with reference to FIG. 1.

FIG. 1 shows a comparison between the adsorption energy of carbon dioxide (CO₂) on the (001) plane of tantalum carbide (TaC) and the adsorption energy of carbon dioxide (CO₂) on the (001) plane of niobium carbide (NbC) derived from electronic structure calculations using density functional theory (“CO₂ adsorption” in the upper right of FIG. 1). FIG. 1 also shows a comparison between the adsorption energy of carbon monoxide (CO) on the (001) plane of tantalum carbide (TaC) and the adsorption energy of carbon monoxide (CO) on the (001) plane of niobium carbide (NbC) derived from electronic structure calculations using density functional theory (“CO adsorption” in the upper right of FIG. 1).

Generally, a catalytic reaction requires moderate adsorption energy. For example, it is reported that the energy required to adsorb CO on the surface of catalytically reactive copper is −0.62 eV (B. Hammer et al., Phys. Rev. Lett, 76 2141 (1996)). The larger adsorption energy is, the less likely catalytic reaction occurs. This is because the larger the adsorption energy is, the stronger the adsorption is, which makes the catalytic reaction less likely to occur. As shown in the left of FIG. 1 (single metal), a single metal such as tantalum and niobium provides an adsorption energy of about −6 eV for CO. This means that the adsorption of CO on the electrode made of single metal such as tantalum and niobium is too strong to initiate a catalytic reaction.

On the other hand, as shown in the right of FIG. 1 (carbide), it was found that with respect to a carbide of tantalum or niobium, the CO adsorption energy is smaller, at around −1 eV. It was further confirmed that CO₂ is adsorbed thereon with a much smaller energy (“CO₂ adsorption” in the upper right of FIG. 1). Therefore, presumably, with respect to tantalum carbide and niobium carbide, the adsorption of CO and CO₂ is not strong and a catalytic reaction is ready to begin.

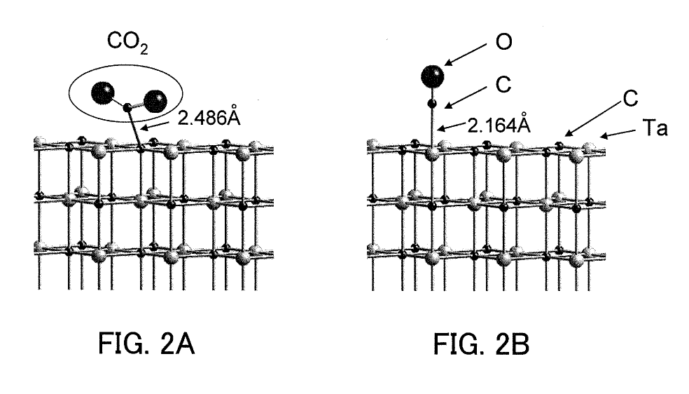

This presumably indicates that CO₂ first was adsorbed to the solid surface of an electrode (i.e., a carbon dioxide reduction catalyst formed on the electrode, hereinafter referred to as a “catalyst”) and then reduced to CO by protons, and part of CO contributed to the production of formic acid, methane and ethane. The electronic structure of the copper surface was calculated in the same manner, but a stable structure in which carbon dioxide is adsorbed on the copper surface (for example, a structure as shown in FIG. 2A) was not obtained. It is known that in the reduction of carbon dioxide, a high overvoltage is needed in the process in which one electron moves to a carbon dioxide molecule, and then the molecule is adsorbed on the catalyst surface. When copper was used as a catalyst, a stable structure in which carbon dioxide is adsorbed on the copper surface was not obtained, as mentioned above. Therefore, presumably, a high overvoltage was needed in the process of adsorbing a carbon dioxide molecule on the catalyst surface. In contrast, carbon dioxide is adsorbed on the surface of the catalytic material of the present invention (i.e., a carbide of a Group V element) at a smaller adsorption energy (see FIG. 1), which seems to decrease the overvoltage for the reduction of carbon dioxide. As described above, the material of the present invention is considered to be able to reduce carbon dioxide at an overvoltage equal to or lower than the overvoltages for the reduction by conventional carbon dioxide reduction catalysts.

FIG. 2A shows the adsorption state of carbon dioxide on the surface of the catalyst described above (the (001) plane of TaC), and FIG. 2B shows the adsorption state of carbon monoxide thereon. The adsorption states shown in FIG. 2A and FIG. 2B were obtained by calculations based on the density functional theory. The numerals shown in these diagrams each denote the distance from the surface element in the stable structure. As shown in FIG. 2A, the distance between TaC and CO₂ adsorbed on TaC is 2.486 Å. As shown in FIG. 2B, the distance between TaC and CO adsorbed on TaC is 2.164 Å. These distances are greater than the distance (about 1.1 Å) between C and O in carbon monoxide. This reflects that the adsorption energy between TaC and CO₂ and the adsorption energy between TaC and CO are small.

As described above, according to the carbon dioxide reduction method and the carbon dioxide reduction device of the present embodiment, a reduction reaction can be carried out only with an external DC power supply at ordinary temperatures and pressures, unlike a vapor phase reduction reaction of carbon dioxide under a high temperature and high pressure environment. The present embodiment can also be applied to more environmentally-friendly methods and devices. For example, it can be applied to the use of a solar cell as an external power supply, and to a catalyst for solar energy reduction by combination with a photocatalyst.

On the other hand, a gas serving as a reducing agent, commonly hydrogen, must be prepared additionally for the vapor phase reaction, and thus the temperature and pressure must be set to accelerate the reaction. For example, a temperature of 300 degrees and a pressure of 50 atmospheres must be set as the conditions for hydrogenation. To satisfy the conditions, large-scale equipment must be installed.

In contrast, the carbon dioxide reduction method and the carbon dioxide reduction device of the present embodiment are very promising techniques, as energy-saving measures for carbon dioxide, in places where large-scale equipment cannot be installed, in houses and communities.

In the present embodiment, the uses of vanadium carbide, niobium carbide, and tantalum carbide, as carbon dioxide reduction catalysts, have been described as examples. A catalyst containing two or more of them also may be used. Any material can be used as long as it contains a carbide of at least one element selected from vanadium, niobium, and tantalum.

The carbon dioxide reduction reaction using the carbon dioxide reduction catalyst of the present invention can be carried out by, for example, blowing carbon dioxide into an electrolytic solution that is a liquid composition or introducing carbon dioxide through a flow system. That is, the reduction reaction can be carried out as a very simple reaction. The present invention is described in more detail by the following examples.

### EXAMPLES

### Example 1

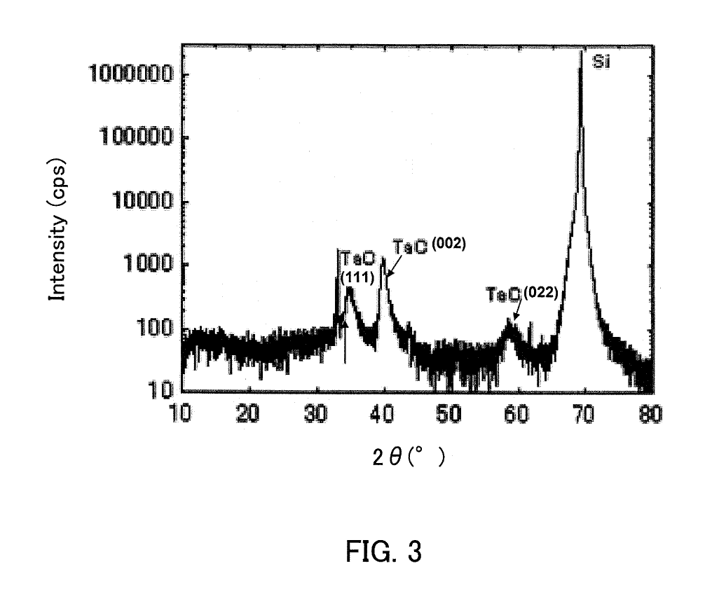

First, as an electrode substrate, a 1 cm square conductive silicon substrate was prepared. A chamber was pumped down to a vacuum of 1.0×10⁻⁴ Pa, and then argon gas was introduced into the chamber. A thin film of tantalum carbide was deposited at a thickness of about 3000 Å on the electrode substrate by sputtering at a power of 100 W in an argon gas atmosphere of 1.0×10⁻¹ Pa. The crystalline structure of tantalum carbide was evaluated by X-ray diffraction. FIG. 3 shows the X-ray diffraction pattern of tantalum carbide. As shown with arrows in the diffraction pattern of FIG. 3, peaks corresponding to the crystalline structure of tantalum carbide having a sodium chloride structure were observed.

This result of the X-ray diffraction confirmed that a crystalline thin film of tantalum carbide was deposited on the silicon substrate (electrode substrate), although tantalum carbide thus deposited was in a polycrystalline state having different plane indices.

FIG. 4 shows a schematic view of an electrochemical cell used for the measurements in this example. The electrochemical cell used in this example was a three-electrode cell provided with a working electrode 41, a reference electrode 42, and a counter electrode 43, and was further provided with a potentiostat 44. In this electrochemical cell, an electrolytic solution 47 was contained in a vessel 48, and the electrodes 41 to 43 were immersed in the electrolytic solution 47. A solid electrolyte membrane 45 was placed between the working electrode 41 and the counter electrode 43 while being immersed in the electrolytic solution 47. This solid electrolyte membrane 45 separated the vessel 48 into the region of the working electrode 41 and the region of the counter electrode 43. This electrochemical cell was provided with a gas inlet 46 for introducing carbon dioxide into the electrolytic solution 47.

The above-mentioned electrode prepared in this example was used as the working electrode 41, a silver/silver chloride electrode was used as the reference electrode 42, and a platinum electrode was used as the counter electrode 43. In this three-electrode cell, the potentiostat 44 was used to sweep the potential, and the evaluation was performed. As the electrolytic solution 47, 0.1 M (0.1 mol/L) potassium bicarbonate solution was used. The solid electrolyte membrane 45 serving as a partition between the region of the working electrode 41 and the region of the counter electrode 43 had also a function of preventing gas components produced from mixing with each other. Carbon dioxide was introduced into the cell through the gas inlet 46, and bubbled into the electrolytic solution 47 of potassium bicarbonate.

First, (1) nitrogen was bubbled into the electrolytic solution 47 at a rate of 100 ml/min for 30 minutes, and while removing carbon dioxide from the electrolytic solution 47, the potential was swept to record the C-V (current-potential) curve. Next, (2) the gas inlet was switched from nitrogen to carbon dioxide and carbon dioxide was also bubbled into the electrolytic solution 47 at a rate of 100 ml/min for 30 minutes, and while saturating the electrolytic solution 47 with carbon dioxide, the potential was swept to record the C-V curve. The difference between the C-V curve obtained when carbon dioxide was removed from the electrolytic solution 47 and the C-V curve obtained when the electrolytic solution 47 was saturated with carbon dioxide was calculated. Thus, a current produced by the reduction of carbon dioxide was evaluated.

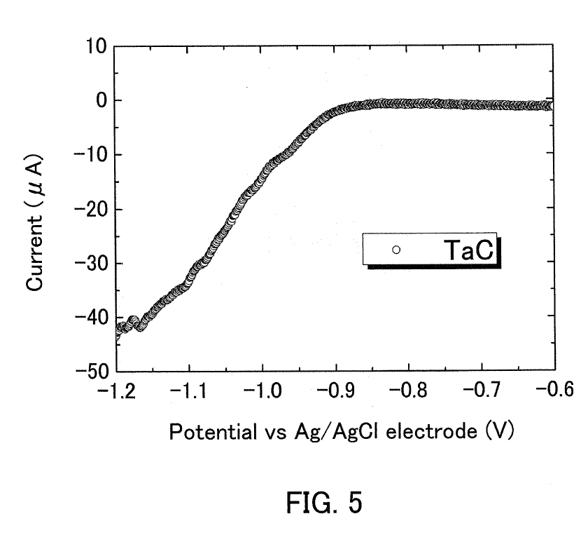

FIG. 5 shows the result of the evaluation. Generally, when a carbon dioxide reduction current is observed in such an evaluation, there occurs a phenomenon that the current falls from zero to a negative value just before the reduction current is observed. As shown in FIG. 5, the experiment in this example shows that the current falls from zero to a negative value just before the potential of −0.9 V. That is, in the case of tantalum carbide, a reduction current was observed when the potential was about −0.9 V with respect to that of a silver/silver chloride electrode. This means that the reduction starts when the potential is −0.7 V with respect to a standard hydrogen electrode.

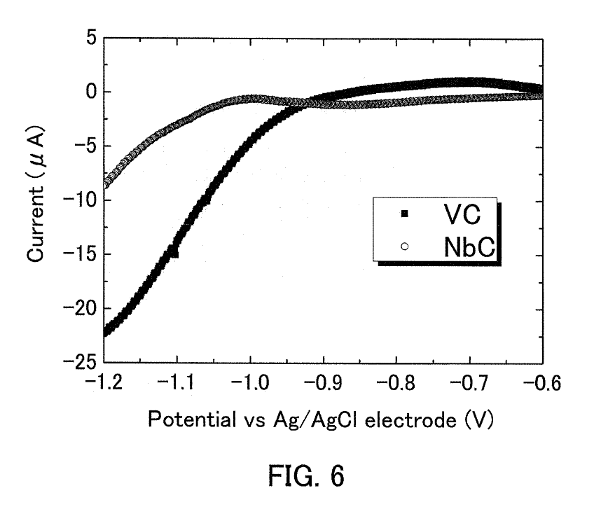

The same experiment was performed for niobium carbide and vanadium carbide. FIG. 6 shows the results. In the case of vanadium carbide, a current was observed when the potential was about −0.9 V, while in the case of niobium carbide, a current was observed when the potential was about −1.05 V. That is, in the case of vanadium carbide, a reduction current was observed when the potential was about −0.9 V, while in the case of niobium carbide, a reduction current was observed when the potential was about −1.05 V.

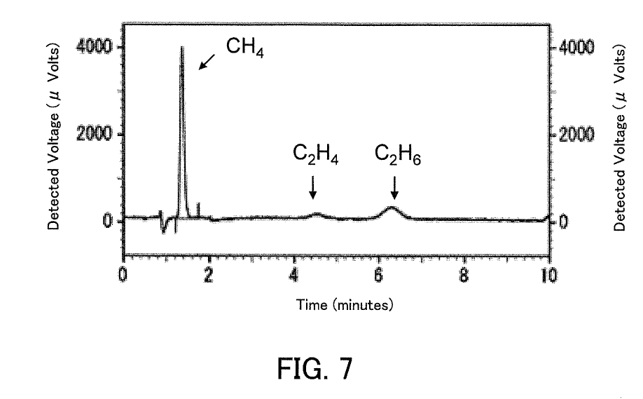

Next, the products of the carbon dioxide reduction in the case of tantalum carbide was analyzed. A gas chromatograph equipped with a hydrogen flame ionization detector (FID) (hereinafter referred to as a FID gas chromatograph) was used to analyze gas components. A liquid chromatograph was used to analyze liquid components. FIG. 7 shows the result of FID gas chromatographic measurement, which confirmed the production of methane, ethylene, and ethane.

This FID gas chromatograph was equipped with a Porapak Q separation column, and programmed so as to control the valve according to a predetermined time sequence, so that methane, ethylene, and ethane were detected after the elapse of about 1.5 minutes, 4.5 minutes, and 6.5 minutes, respectively from the start of the measurement. As a result, voltage peaks were observed at about 1.5 minutes, 4.5 minutes, and 6.5 minutes, as shown in FIG. 7, and thus the production of methane, ethylene, and ethane was confirmed.

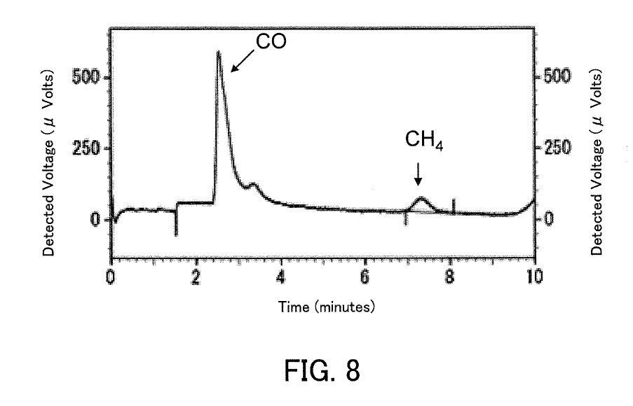

FIG. 8 shows the result of FID gas chromatographic measurement using a Porapak N separation column, which confirmed the production of carbon monoxide. In this case also, as with the above case, the FID gas chromatograph was programmed so as to control the valve according to a predetermined time sequence, so that carbon monoxide and methane were detected after the elapse of about 2.5 minutes and 6.5 minutes, respectively from the start of the measurement. As a result, voltage peaks were observed at about 2.5 minutes and 6.5 minutes, as shown in FIG. 8, and thus the production of carbon monoxide and methane was confirmed.

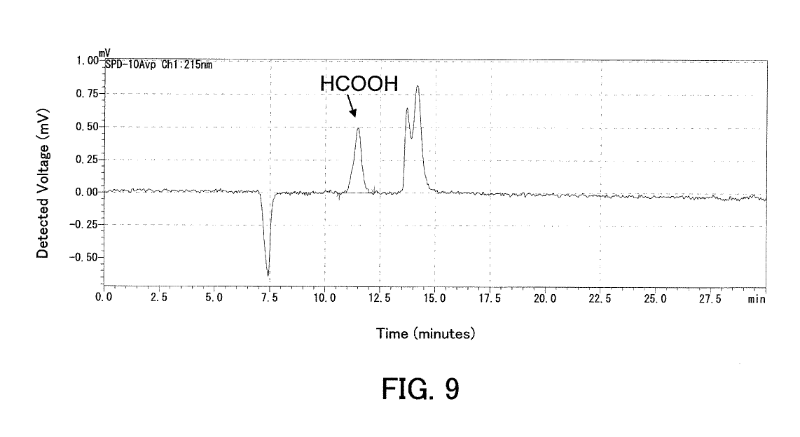

FIG. 9 shows the result of liquid chromatographic measurement, which confirmed the production of formic acid. A TSKgel SEC—H+ column was used, and the chromatograph was controlled so that the peak of formic acid was observed after the elapse of about 11.5 minutes from the start of the measurement. As a result of the measurement, the voltage peak was observed at about this time. This confirmed the production of formic acid.

As described above, the production of carbon monoxide, formic acid, methane, ethylene, and ethane was finally confirmed based on the analysis of the products.

These results show that when a carbon compound of a Group V element, such as tantalum carbide, is used as a carbon dioxide reduction catalyst, carbon dioxide is reduced to produce carbon monoxide, formic acid, methane, ethylene, and ethane, as products. As also described in the embodiment, a carbon compound of a Group V element, such as tantalum carbide, is considered to be able to reduce carbon dioxide at an overvoltage equal to or lower than the overvoltages for the reduction of carbon dioxide by conventional carbon dioxide reduction catalysts. Generally speaking, compounds such as tantalum carbide, niobium carbide, and vanadium carbide are more durable in solutions than single metals and metal complexes. Therefore, it can be said that the carbon dioxide reduction catalyst of the present invention has excellent durability, and achieves reduction of carbon dioxide at an overvoltage equal to or lower than the overvoltages for the reduction of carbon dioxide by conventional carbon dioxide reduction catalysts.

Based on this, according to the carbon dioxide reduction catalyst of the present invention, and further the carbon dioxide reduction method and the carbon dioxide reduction device of the present invention using this catalytic material, a reduction reaction can be carried out in an energy-saving manner, only with an external DC power supply at ordinary temperatures and pressures. The present invention can also be applied to more environmentally-friendly uses. For example, it can be applied to the use of a solar cell as an external power supply, and to a catalyst for solar energy reduction by combination with a photocatalyst.

### Comparative Example 1

For comparison, how carbon dioxide was reduced when carbon was used as a catalyst was examined. The electrolytic reaction was carried out in the same manner as in Example 1, except that a carbon paper electrode was prepared and used as a working electrode. As a result, a reduction current generated by the CO₂ reduction was not observed, carbon was inactive in the CO₂ reduction, and only one product of the electrolytic reaction was hydrogen (H₂).

### Comparative Example 2

For comparison, how carbon dioxide was reduced when a carbide of a metal element other than Group V elements was used as a catalyst was examined. Particles of titanium (Ti) carbide, molybdenum (Mo) carbide, etc. were prepared, and then working electrodes in which the particles of each carbide were supported on carbon paper were prepared. The electrolytic reaction was carried out in the same manner as in Example 1, except that these working electrodes were used. As a result, these carbides exhibited the same characteristics as the carbon paper used as a substrate. Only H₂ was produced, and no other products such as CO, hydrocarbon, and HCOOH were obtained.

### INDUSTRIAL APPLICABILITY

The present invention demonstrates that carbon dioxide is allowed to be reduced on a highly durable compound, i.e., a carbide of a Group V element, at a lower overvoltage. The present invention not only can provide carbon monoxide, formic acid, methane, etc. obtained by reducing carbon dioxide with less energy and at lower cost, but also can be used as a technique for reducing the amount of carbon dioxide.

What is claimed is:

1. A carbon dioxide reduction method comprising steps of:
bringing an electrode containing, as a carbon dioxide reduction catalyst, only a carbide of at least one element selected from Group V elements (vanadium, niobium, and tantalum) into contact with an electrolytic solution; and
introducing carbon dioxide into the electrolytic solution to reduce the introduced carbon dioxide by the electrode.

2. A carbon dioxide reduction catalyst used for an electrode that is placed in contact with an electrolytic solution so as to reduce carbon dioxide in the electrolytic solution, the catalyst consisting of a carbide of at least one element selected from Group V elements (vanadium, niobium, and tantalum).

3. A carbon dioxide reduction device comprising:
an electrolytic solution;
a vessel containing the electrolytic solution;
a first electrode placed in contact with the electrolytic solution and containing, as a carbon dioxide reduction catalyst, only a carbide of at least one element selected from Group V elements (vanadium, niobium, and tantalum);
a second electrode placed in contact with the electrolytic solution and electrically connected to the first electrode;
a solid electrolyte placed between the first electrode and the second electrode to separate the vessel into a region of the first electrode and a region of the second electrode; and
a gas inlet for introducing carbon dioxide into the electrolytic solution.
